(19) United States
(12) Patent Application Publication
(10) Pub. No.: US 2012/0028091 A1
(43) Pub. Date: Feb. 2, 2012

(54) SECONDARY BATTERY

(76) Inventor: Ki-Soo PARK, Yongin-si (KR)

(21) Appl. No.: 13/187,555

(22) Filed: Jul. 21, 2011

(30) Foreign Application Priority Data
Jul. 29, 2010 (KR) 10-2010-0073445

(51) Int. Cl. H01M 10/36

(52) U.S. Cl. 429/94

(57) ABSTRACT

A secondary battery including a wound electrode assembly formed by winding a positive electrode plate having a positive electrode tab fixed thereto, a negative electrode plate having a negative electrode tab fixed thereto, and a separator interposed therebetween, and pressing them in one side direction thereof, the wound electrode assembly having a seam at one side thereof; a battery case having an opening through which the wound electrode assembly is accommodated; a cap plate sealing the opening of the battery case; and a protection tape covering at least a portion of the seam, the protection tape including an aramid fiber.

### BACKGROUND

1. Field

Embodiments relates to a secondary battery.

2. Description of the Related Art

A variety of batteries may be used as power sources of small-sized electronic devices. Among them, batteries using an electrolyte, e.g., lithium secondary batteries, that are small-sized, large-capacity, and sealed-type batteries, may be used as power sources of, e.g., mobile phones, notebook computers, camcorders, and the like. Batteries having a cylindrical or prismatic structure may be used as such electrolyte batteries.

For example, a lithium ion secondary battery may be manufactured by accommodating a winding type or wound electrode assembly in a battery case, injecting an electrolyte into the battery case, and then sealing the battery case. The wound electrode assembly may be formed by coating active materials on respective positive and negative electrode collectors, interposing a separator between the positive and negative electrode collectors, and then winding the positive and negative electrode collectors and the separator.

Such lithium ion secondary batteries may be classified into a cylindrical battery having a wound electrode assembly accommodated in a cylindrical battery case and a prismatic battery having a wound electrode assembly accommodated in a prismatic battery case. The prismatic battery may be used in small or thin devices having a rectangular battery accommodating portion.

In order to accommodate an electrode assembly in a battery case of a prismatic battery, the electrode assembly may be wound and fixed by a finishing tape that surrounds an outer surface thereof. Then, the electrode assembly may be pressed.

Although methods for forming the positive and negative electrode plates may be slightly different according to the kinds of secondary batteries, the positive and negative electrode plates are usually formed by coating and charging an active material on a base metal and then drying, roll-pressing, and cutting the base metal.

### SUMMARY

Embodiments are directed to a secondary battery.

At least one of the above and other features and advantages may be realized by providing a secondary battery including a wound electrode assembly formed by winding a positive electrode plate having a positive electrode tab fixed thereto, a negative electrode plate having a negative electrode tab fixed thereto, and a separator interposed therebetween, and pressing them in one side direction thereof, the wound electrode assembly having a seam at one side thereof; a battery case having an opening through which the wound electrode assembly is accommodated; a cap plate sealing the opening of the battery case; and a protection tape covering at least a portion of the seam, the protection tape including an aramid fiber.

The aramid fiber may include at least one of Nomex, Kevlar, Twaron,

Technora, and MetaOne.

The protection tape may be attached in a longitudinal direction along the seam.

The protection tape may cover a base of at least one of the positive and negative electrode tabs.

The protection tape may cover a bottom surface of the electrode assembly, the bottom surface being opposite to and end of the electrode assembly including the positive and negative electrode tabs, a portion of a side surface of the electrode assembly, the portion extending a predetermined length in the longitudinal direction from the bottom surface of the electrode assembly and along the seam of the electrode assembly.

The protection tape may cover an entire side surface of the electrode assembly, the entire side surface including the winding longitudinal section of the electrode assembly.

The protection tape may be attached through adhesion or through heat contraction.

At least one of the above and other features and advantages may also be realized by providing a secondary battery including a wound electrode assembly, the wound electrode assembly including a winding of a positive electrode plate having a positive electrode tab fixed thereto, a negative electrode plate having a negative electrode tab fixed thereto, and a separator interposed therebetween, wherein the wound electrode assembly has a seam at one side thereof; a battery case having an opening through which the wound electrode assembly is accommodated; a cap plate sealing the opening of the battery case; and a protection tape covering at least a portion of the seam, the protection tape including an aramid fiber.

### BRIEF DESCRIPTION OF THE DRAWINGS

The above and other features and advantages will become more apparent to one of ordinary skill in the art by describing in detail exemplary embodiments with reference to the attached drawings, in which:

FIG. 1 illustrates an exploded perspective view of a lithium secondary battery according to an embodiment;

FIG. 2 illustrates a perspective view of an electrode assembly of FIG. 1;

FIG. 3 illustrates a perspective view of an electrode assembly according to another embodiment;

FIG. 4A illustrates a perspective view of an electrode assembly according to yet another embodiment;

FIG. 4B illustrates a bottom perspective view of the electrode assembly of FIG. 4A;

FIG. 5A illustrates a perspective view of an electrode assembly according to still another embodiment;

FIG. 5B illustrates a bottom perspective view of the electrode assembly of FIG. 5A;

FIG. 6A illustrates a perspective view of an electrode assembly according to still another embodiment;

FIG. 6B illustrates a bottom perspective view of the electrode assembly of FIG. 6A.

### DETAILED DESCRIPTION

Korean Patent Application No. 10-2010-0073445, filed on Jul. 29, 2010, in the Korean Intellectual Property Office, and entitled: “Secondary Battery” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

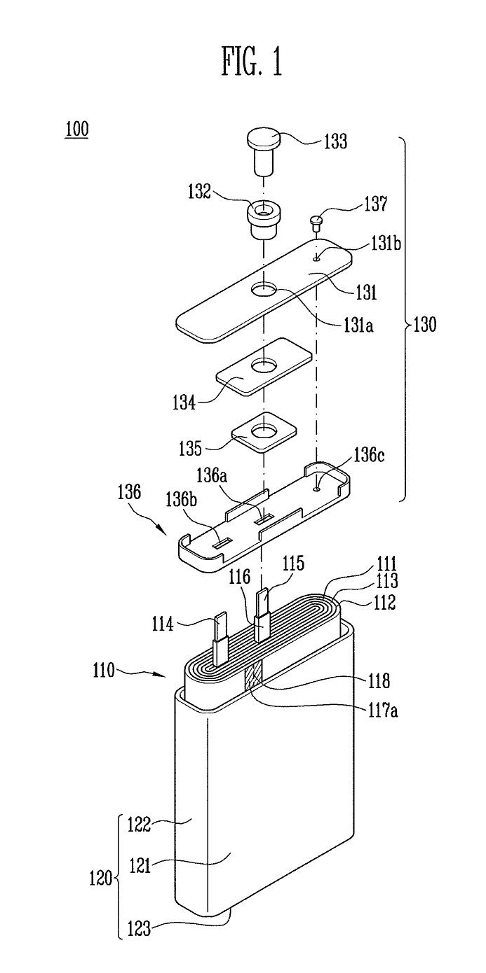

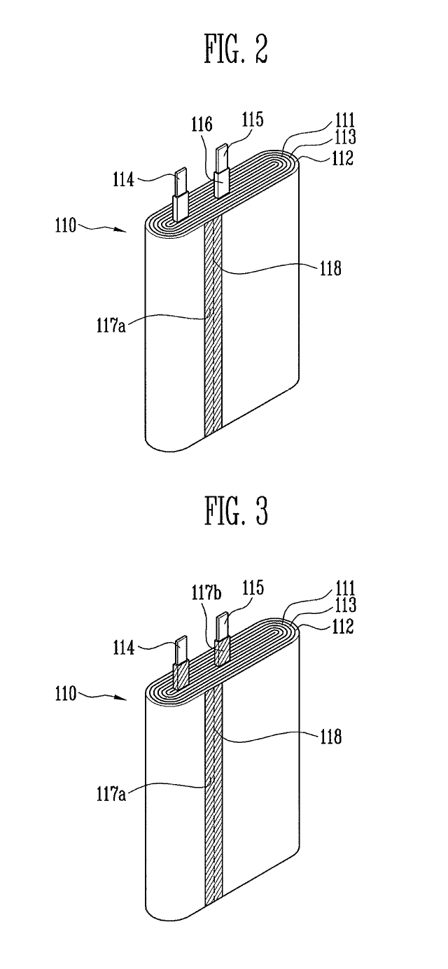

Hereinafter, a secondary battery according to an embodiment will be described in detail with reference to FIGS. 1 and 2. FIG. 1 illustrates an exploded perspective view of a secondary battery according to an embodiment. FIG. 2 illustrates a perspective view of an electrode assembly of FIG. 1.

The, e.g., lithium, secondary battery 100 according to the present embodiment may include an electrode assembly 110, a battery case 120, and a cap assembly 130.

The electrode assembly 110 may include a positive electrode plate 111, a negative electrode plate 112, and a separator 113 interposed therebetween. The electrode assembly 110 may further include positive and negative electrode tabs 114 and 115, each having one end portion fixed to the electrode assembly 110, and another end protruding upwardly from a top of the electrode assembly 110. For example, the positive electrode tab 114 may extend from the positive electrode plate 111; and the negative electrode tab 115 may extend from the negative electrode plate 112. The positive and negative electrode tabs 114 and 115 may be formed of, e.g., aluminum (Al), nickel (Ni), copper (Cu), or the like. In an implementation, the positive electrode tab 114 may be formed of Al and the negative electrode tab 115 may be formed of Ni. A portion at which each of the positive and negative electrode tabs 114 and 115 protrudes upwardly from the top portion of the electrode assembly 110, e.g., a base, may be wound with an insulation tape 116 for preventing a short circuit between the electrode plates 111 and 112. In order to increase an electrical capacity of the electrode assembly 110, the electrode assembly 110 may be manufactured by stacking the positive electrode plate 111, the negative electrode plate 112, and the separator 113 interposed therebetween, and then winding them in the shape of a jelly roll. In an implementation, positive and negative electrode active materials may be coated on the positive and negative electrode plates 111 and 112, respectively. The positive electrode active material may include, e.g., a lithium-manganese-based oxide with high stability; and the negative electrode active material may include, e.g., a carbon-based oxide. However, the materials are not limited thereto.

The electrode assembly 110 according to the present embodiment may include a first protection tape 117a attached in a longitudinal direction along a seam 118 of the electrode assembly 110 formed while sequentially winding the positive electrode plate 111, the separator 113, and the negative electrode plate 112. Then, the electrode assembly 110 may be pressed.

As described above, although methods for forming the positive and negative electrode plates 111 and 112 may be slightly different according to the kinds of secondary batteries, the positive and negative electrode plates 111 and 112 may be formed by coating and charging an active material on a base metal and then drying, roll-pressing, and cutting the base metal. After the positive electrode plate 111, the separator 113, and the negative electrode plate 112 are wound as described above, a small burr may exist at a cut-away surface of the positive and negative electrode plates 111 and 112. Accordingly, in order to prevent an electrical short and explosion of the secondary battery, the first protection tape 117a may be attached to the seam 118. Thus, the process of pressing the electrode assembly 110 may be easily and safely performed.

According to an embodiment, the first protection tape 117a may include an aramid fiber. For example, the aramid fiber may include Nomex from DuPont, Kevlar from DuPont, Twaron from Teijin Aramid, Technora from Teijin Limited, and/or MetaOne. The aramid fiber is a material that exhibits excellent burr suppression and compensation characteristics, unlike resins such as polyethylene or polypropylene. Thus, the first protection tape 117a may be attached in the longitudinal direction along the seam 118 of the wound electrode assembly 110. The electrode assembly 110 may then be pressed and adverse effects from any burrs or other pressure problems may be reduced.

An opening (through which the electrode assembly 110 is inserted in the battery case 120) may be formed at the top of the battery case 120. A space for accommodating the electrode assembly 120 may be formed in an interior of the battery case 120. The opening may be sealed by the cap assembly 130. The battery case 120 may include two long-side walls 121 opposite to each other, two short-side walls opposite to each other, and a bottom plate 123 that connects them. The bottom plate 123 may correspond to the opening at the top of the battery case 120 and may be formed as a closed surface. The bottom plate 123 may be connected to lower portions of the long-side and short-side walls 121 and 122 so that they are formed in a single body. The bottom plate 123 may support a structure or object accommodated in the battery case 120. For example, the battery case 120 may be made of a metal material, may have the shape of a rectangular parallelepiped with an opening at one end of a prismatic secondary battery, and may be formed by a machining process such as deep drawing. The battery case 120 may be formed of, e.g., Al or Al alloy, which is a light and conductive metal. Thus, the battery case itself may serve as a terminal.

The cap assembly 130 may be mounted on the top of the battery case 120 and then coupled thereto by, e.g., welding. The cap assembly 130 may include a cap plate 131, a gasket 132, an electrode terminal 133, an insulation plate 134, a terminal plate 135, an insulation case, and a stopper 137.

The cap plate 131 may include a terminal through-hole 131a and an electrolyte injection hole 131b. The terminal through-hole 131a may provide a path through which the electrode terminal 133 is inserted. In an implementation, in order to insulate the cap plate 131 and the electrode terminal 133, which have metallic properties, from each other, the electrode terminal 133 may be inserted into the terminal through-hole 131a in a state that the gasket 132 made of an insulation material is mounted on a sidewall thereof. The electrolyte injection hole 131b for injecting an electrolyte into the battery case 120 may be formed at one side of the cap plate 131. The electrolyte may be injected into the battery case 120 through the electrolyte injection hole 131b; and the electrolyte injection hole 131b may be sealed by the stopper 137, thereby preventing leakage of the electrolyte.

The insulation plate 134 may be formed beneath the cap plate 131. The terminal plate 135 may be formed beneath the insulation plated 134. Thus, the insulation plate 134 may insulate the cap plate 131 and the terminal plate 135 from each other. The terminal plate 135 may be coupled to a lower portion of the electrode terminal 133. Thus, the negative electrode plate 112 of the electrode assembly 110 may be electrically connected to the electrode terminal 133 through the negative electrode tab 115 and the terminal plate 135. In an implementation, the positive electrode plate 111 of the electrode assembly 110 may be electrically connected to the cap plate 131 or the battery case 120 through the positive electrode tab 114.

The insulation case 136 may be formed beneath the terminal plate 135. The insulation case 136 may include a negative electrode tab through-hole 136a, a positive electrode tab through-hole 136b, and an electrolyte inlet 136c.

The stopper 137 may seal the electrolyte injection hole 131b after injection of the electrolyte. In addition to the stopper 137, the electrolyte injection hole 131b may be sealed by press-fitting a ball thereinto.

Hereinafter, a secondary battery according to another embodiment will be described in detail with reference to FIG. 3. FIG. 3 illustrates a perspective view of an electrode assembly according to another embodiment.

The secondary battery according to the present embodiment may have the same components as the secondary battery according to the previous embodiment, except for a position of the protection tape. Therefore, the same components are designated by the same reference numerals, and repeated descriptions will be omitted. Accordingly, in the present embodiment, the position of the protection tape, which is different from that in the previous embodiment, will be mainly described.

The electrode assembly 110 according to the present embodiment may include the first protection tape 117a attached in the longitudinal direction along the seam 118 of the electrode assembly 110 formed by sequentially winding the positive electrode plate 111, the separator 113, and the negative electrode plate 112. Then, the electrode assembly 110 may be pressed. A portion at which each of the positive and negative electrode tabs 114 and 115 protrude upwardly from a top portion of the /electrode assembly 110, e.g., the base, may be wound with a second protection tape 117b.

The first and second protection tapes 117a and 117b according to the present embodiment may include an aramid fiber. For example, the aramid fiber may include Nomex from DuPont, Kevlar from DuPont, Twaron from Teijin Aramid, Technora from Teijin Limited, and/or MetaOne. The aramid fiber is a material that exhibits excellent burr suppression and compensation characteristics, unlike resins such as polyethylene or polypropylene. Thus, the first protection tape 117a may be attached in the longitudinal direction along the seam 118 of the wound electrode assembly 110; and the second protection tape 117b may be attached to the base of at least one of the positive and negative electrode tabs 114 and 115. The electrode assembly 110 may then be pressed; and adverse effects from any burrs or other pressure problems may be reduced.

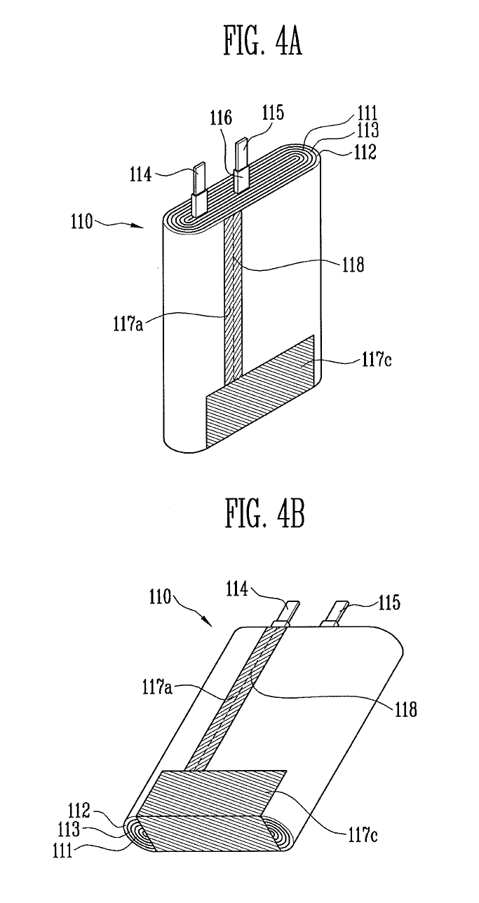

Hereinafter, a secondary battery according to yet another embodiment will be described in detail with reference to FIGS. 4A and 4B. FIG. 4A illustrates a perspective view of an electrode assembly according to another embodiment. FIG. 4B illustrates a bottom perspective view of the electrode assembly of FIG. 4A.

The secondary battery according to the present embodiment may have the same components as the secondary battery according to the previous embodiments, except for a position of the protection tape. Therefore, the same components are designated by the same reference numerals, and repeated overlapping descriptions will be omitted. Accordingly, in the present embodiment, the position of the protection tape, which is different from those in the previous embodiments of the present invention, will be mainly described.

The electrode assembly 110 according to the present embodiment may include the first protection tape 117a attached in the longitudinal direction along the seam 118 of the electrode assembly 110 formed by sequentially winding the positive electrode plate 111, the separator 113, and the negative electrode plate 112. Then, the electrode assembly 110 may be pressed. A third protection tape 117c may cover a bottom surface of the electrode assembly 110, e.g., a side of the electrode assembly 110 opposite to a side including the positive and negative electrode tabs 114 and 115. The third protection tape 117c may also cover a portion of a side surface of the electrode assembly 110, which may extend a predetermined length in the longitudinal direction of the electrode assembly 110 from the bottom surface.

The first and second protection tapes 117a and 117c according to the present embodiment may include an aramid fiber. For example, the aramid fiber may include Nomex from DuPont, Kevlar from DuPont, Twaron from Teijin Aramid, Technora from Teijin Limited, and/or MetaOne. The aramid fiber is a material that exhibits excellent burr suppression and compensation characteristics, unlike resins such as polyethylene or polypropylene. Thus, the first protection tape 117a may be attached in the longitudinal direction along the seam 118 of the wound electrode assembly 110; and the third protection tape 117c may be attached to bottom and side surfaces of the electrode assembly 110. The electrode assembly 110 may then be pressed; and adverse effects from any burrs or other pressure problems may be reduced.

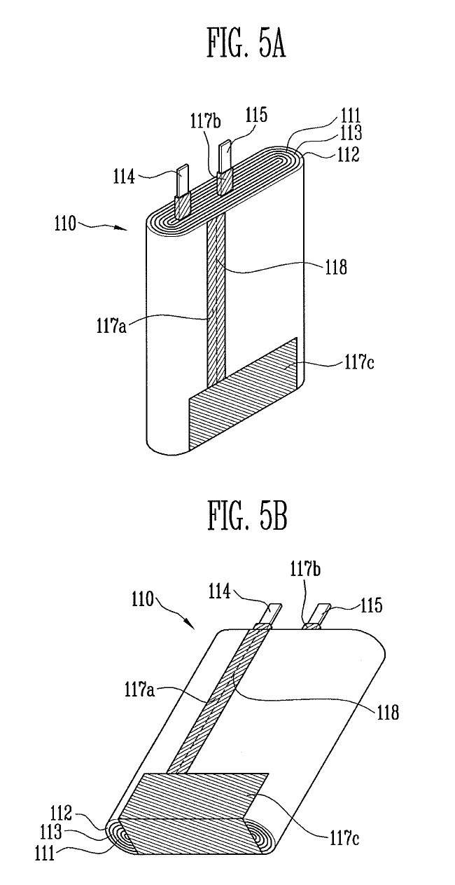

Hereinafter, a secondary battery according to still another embodiment will be described in detail with reference to FIGS. 5A and 5B. FIG. 5A illustrates a perspective view of an electrode assembly according to still another embodiment. FIG. 5B illustrates a bottom perspective view of the electrode assembly of FIG. 5A.

The secondary battery according to the present embodiment may have the same components as the secondary battery according to the previous embodiments, except for a position of the protection tape. Therefore, the same components are designated by the same reference numerals, and repeated descriptions will be omitted. Accordingly, in the present embodiment, the position of the protection tape, which may be different from those in the previous embodiments, will be mainly described.

The electrode assembly 110 according to the present embodiment may include the first protection tape 117a attached in the longitudinal direction along the seam 118 of the electrode assembly 110 formed by sequentially winding the positive electrode plate 111, the separator 113, and the negative electrode plate 112. Then, the electrode assembly 110 may be pressed. Portions at which each of the positive and negative electrode tabs 114 and 115 protrudes upwardly from the top portion of the electrode assembly 110, e.g., the base, may be wound with the second protection tape 117b. The third protection tape 117c may cover a bottom surface of the electrode assembly 110, e.g., a side of the electrode assembly 110 opposite to a side including the positive and negative electrode tabs 114 and 115. The third protection tape 117c may also cover a portion of a side surface of the electrode assembly 110, which may extend along a predetermined length of the electrode assembly 110 from the bottom surface.

The first, second, and third protection tapes 117a, 117b, and 117c according to the present embodiment may include an aramid fiber. For example, the aramid fiber may include Nomex from DuPont, Kevlar from DuPont, Twaron from Teijin Aramid, Technora from Teijin Limited, and/or MetaOne. The aramid fiber is a material that exhibits excellent burr suppression and compensation characteristics, unlike resins such as polyethylene or polypropylene. Thus, the first protection tape 117a may be attached in the longitudinal direction along the seam 118 of the wound electrode assembly 110. The second protection tape 117b may be attached to portion at which each of the positive and negative electrode tabs 114 and 115 protrudes upwardly from the top portion of the electrode assembly 110, e.g., the base; and the third protection tape 117c may be attached to the bottom and side surfaces of the electrode assembly 110. The electrode assembly 110 may then be pressed; and adverse effects from any burrs or other pressure problems may be reduced.

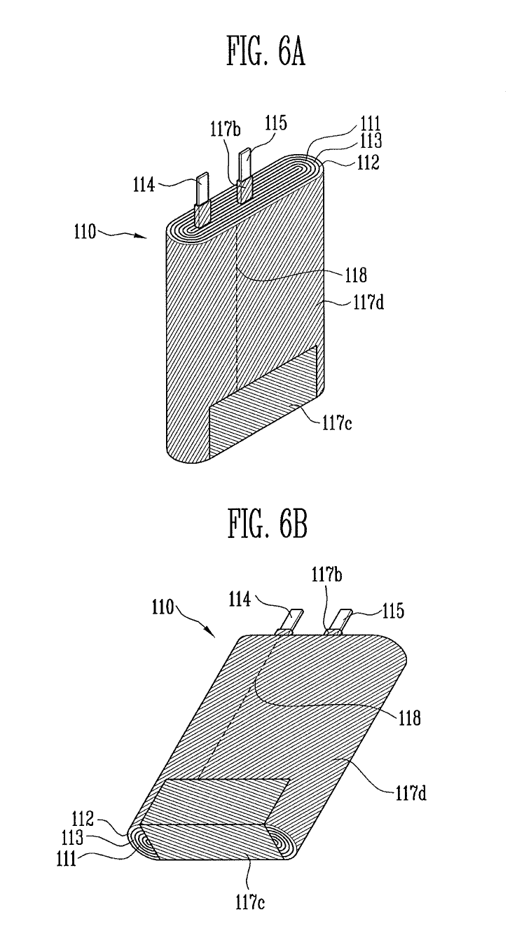

Hereinafter, a secondary battery according to still another embodiment will be described in detail with reference to FIGS. 6A and 6B. FIG. 6A illustrates a perspective view of an electrode assembly according to still another embodiment. FIG. 6B illustrates a bottom perspective view of the electrode assembly of FIG. 6A.

The secondary battery according to the present embodiment may have the same components as the secondary battery according to the previous embodiments, except for a position of the protection tape. Therefore, the same components are designated by the same reference numerals, and repeated descriptions will be omitted. Accordingly, in the present embodiment of the present invention, the position of the protection tape, which is different from those in the previous embodiments, will be mainly described.

In the electrode assembly 110 according to the present embodiment, a fourth protection tape 117d may cover entire side surfaces thereof including the seam 118 of the electrode assembly 110 formed by sequentially winding the positive electrode plate 111, the separator 113, and the negative electrode plate 112. Portion at which each of the positive and negative electrode tabs 114 and 115 protrudes upwardly from the top portion of the electrode assembly 110, e.g., the base, may be wound with the second protection tape 117b. The third protection tape 117c may cover a bottom surface of the electrode assembly 110, which is a surface opposite to a side of the electrode assembly 110 including the positive and negative electrode tabs 114 and 115. The third protection tape 117c may also cover a portion of a side surface of the electrode assembly 110, e.g., may extend a predetermined length in the longitudinal direction along the electrode assembly 110 from the bottom surface.

The fourth, second, and third protection tapes 117d, 117b, and 117c according to the present embodiment may include an aramid fiber. For example, the aramid fiber may include Nomex from DuPont, Kevlar from DuPont, Twaron from Teijin Aramid, Technora from Teijin Limited, and/or MetaOne. The aramid fiber is a material that exhibits excellent burr suppression and compensation characteristics, unlike resins such as polyethylene or polypropylene. Thus, the fourth protection tape 117d may cover the entire side surfaces including the seam 118 of the wound electrode assembly 110. The second protection tape 117b may be wound around portions at which each of the positive and negative electrode tabs 114 and 115 protrudes upwardly from the top portion of the electrode assembly 110. The third protection tape 117c may cover bottom and side surfaces of the electrode assembly 110. The electrode assembly 110 may then be pressed; and adverse effects from any burrs or other pressure problems may be reduced.

According to the embodiments, the protection tape may be attached through, e.g., adhesion or through heat contraction.

In a comparative example, a finishing tape made of, e.g., polyethylene, polypropylene, or the like, may be attached to and surround a seam at which the winding of an electrode jelly roll formed by sequentially winding a positive electrode plate, a separator and a negative electrode plate is finished on an outer circumferential surface of the electrode jelly roll. However, after the positive electrode plate, the separator, and the negative electrode plate are wound as described above, use of resin, e.g., polyethylene or polypropylene, as a material of the finishing tape, may result in an electrical short if even a small burr is generated at a cut-away surface of the positive and negative electrode plates. Accordingly, the electrical short may cause an explosion of the secondary battery. Therefore, the process of pressing the electrode jelly roll may not also be easily performed.

As described above, according to the embodiments, a protection tape made of an aramid fiber may be applied to a seam and other portions of an electrode assembly, so that adverse effects from any burrs or other pressure problems may be reduced.

The embodiments provide a secondary battery that reduces or eliminates adverse effects from a burr at a seam of a wound electrode assembly by suppressing and/or compensating for the burr.

According to the embodiments, it is possible to prevent an electrical short and explosion of the secondary battery, thereby improving the reliability of products.

According to the embodiments, it is possible to minimize failure during a manufacturing process of the secondary battery, thereby decreasing manufacturing cost.

Exemplary embodiments have been disclosed herein, and although specific terms are employed, they are used and are to be interpreted in a generic and descriptive sense only and not for purpose of limitation. Accordingly, it will be understood by one of ordinary skill in the art that various changes in form and details may be made without departing from the spirit and scope of the present invention as set forth in the following claims.

What is claimed is:

1. A secondary battery, comprising:
a wound electrode assembly formed by:
winding a positive electrode plate having a positive electrode tab fixed thereto, a negative electrode plate having a negative electrode tab fixed thereto, and a separator interposed therebetween, and
pressing them in one side direction thereof, the wound electrode assembly having a seam at one side thereof;
a battery case having an opening through which the wound electrode assembly is accommodated;
a cap plate sealing the opening of the battery case; and
a protection tape covering at least a portion of the seam, the protection tape including an aramid fiber.

2. The secondary battery as claimed in claim 1, wherein the aramid fiber includes at least one of Nomex, Kevlar, Twaron, Technora, and MetaOne.

3. The secondary battery as claimed in claim 1, wherein the protection tape is attached in a longitudinal direction along the seam.

4. The secondary battery as claimed in claim 3, wherein the protection tape covers a base of at least one of the positive and negative electrode tabs.

5. The secondary battery as claimed in claim 3, wherein the protection tape covers:
a bottom surface of the electrode assembly, the bottom surface being opposite to and end of the electrode assembly including the positive and negative electrode tabs,
a portion of a side surface of the electrode assembly, the portion extending a predetermined length in the longitudinal direction from the bottom surface of the electrode assembly and
along the seam of the electrode assembly.

6. The secondary battery as claimed in claim 1, wherein the protection tape covers an entire side surface of the electrode assembly, the entire side surface including the winding longitudinal section of the electrode assembly.

7. The secondary battery as claimed in claim 1, wherein the protection tape is attached through adhesion or through heat contraction.

8. A secondary battery, comprising:
a wound electrode assembly, the wound electrode assembly including a winding of a positive electrode plate having a positive electrode tab fixed thereto, a negative electrode plate having a negative electrode tab fixed thereto, and a separator interposed therebetween, wherein the wound electrode assembly has a seam at one side thereof;
a battery case having an opening through which the wound electrode assembly is accommodated;
a cap plate sealing the opening of the battery case; and
a protection tape covering at least a portion of the seam, the protection tape including an aramid fiber.
